(19) United States
(12) Patent Application Publication
(10) Pub. No.: US 2025/0008881 A1
(43) Pub. Date: Jan. 9, 2025

(54) SYSTEMS AND METHODS FOR GROWING CROPS IN A MODULAR ASSEMBLY

(71) Applicant: Tavaci Technologies LLC, Alpine, UT (US)

(72) Inventors: Sean R. Peterson, Payson, UT (US); Johndavid Tueller, Orem, UT (US); Todd Garrett Tueller, Alpine, UT (US); Ryan Joseph Crawford, Salem, UT (US)

(21) Appl. No.: 18/765,067

(22) Filed: Jul. 5, 2024

Related U.S. Application Data
(60) Provisional application No. 63/512,144, filed on Jul. 6, 2023.
(60) Provisional application No. 63/512,129, filed on Jul. 6, 2023.

(51) Int. Cl. A01G 9/029; A01G 7/04; A01G 9/02; A01G 27/00; B65G 1/04

(52) U.S. Cl. CPC A01G 9/0299; A01G 7/045; A01G 9/023; A01G 27/003; B65G 1/0478; B65G 1/0492; B65G 2201/0202

(57) ABSTRACT

The present disclosure presents modular growing systems and related methods for growing crops. One such system comprises a plurality of body frames; a plurality of lift frames positioned at each end of the modular system; wherein the body frames and lift frames are arranged in a plurality of vertically stacked rows, each row comprising at least one body frame and two lift frames, the body frames being positioned between the lift frames in each row; a plurality of subframe supports within each body frame, each subframe support configured to hold at least one cart containing seeds or crops; a lowering lift mechanism within each lift frame, configured to move the carts vertically between the rows of body frames; and/or a controller communicatively coupled to the lowering lift mechanisms and translating mechanisms, configured to operate the movement of the carts through the modular system based on predetermined parameters.

### CROSS-REFERENCE TO RELATED APPLICATION

This application claims priority to co-pending U.S. provisional application entitled, “Systems and Methods for Growing Crops in a Modular Assembly,” having application No. 63/512,144, filed Jul. 6, 2023, and U.S. provisional application entitled, “Systems and Methods for Providing a Modular Grow Pod,” having application No. 63/512,129, filed Jul. 6, 2023, each of which is entirely incorporated herein by reference.

### TECHNICAL FIELD

The present specification generally relates to systems and methods for distributing seed and/or other organic material and, more specifically, systems and methods for growing crops that may be systems shipped and assembled in individual modular parts.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, while the United States currently has suitable farmland to adequately provide food for the U.S. population, other countries and future populations may not have enough farmland to provide the appropriate amount of food.

### SUMMARY

The present disclosure presents modular grow tower systems and related methods for growing crops. One such system comprises a plurality of body frames; a plurality of lift frames positioned at each end of the modular system; wherein the body frames and lift frames are arranged in a plurality of vertically stacked rows, each row comprising at least one body frame and two lift frames, the body frames being positioned between the lift frames in each row; a plurality of subframe supports within each body frame, each subframe support configured to hold at least one cart containing seeds or crops; a lowering lift mechanism within each lift frame, configured to move the carts vertically between the rows of body frames; and/or a controller communicatively coupled to the lowering lift mechanisms and translating mechanisms, configured to operate the movement of the carts through the modular system based on predetermined parameters.

Also disclosed herein is a method comprising providing a plurality of body frames and lift frames; arranging the body frames and lift frames in a plurality of vertically stacked rows; placing carts containing seeds or crops within the body frames; using a lowering lift mechanism to move the carts vertically between the rows of body frames; controlling the movement of the carts through the modular system using a controller; providing water to the carts using an integrated irrigation system; and/or providing light to the carts using an integrated lighting system.

In one or more aspects of such systems and methods, the lowering lift mechanism comprises rollers, tracks, or rack and pinion gears, configured to move the carts vertically between the rows; and/or the lighting system includes high intensity discharge (HID) lights, fluorescent lights, or light-emitting diode (LED) lights mounted within the body frames to emit light towards the carts.

In one or more aspects, such systems and/or methods involve an irrigation system integrated within the body frames, the irrigation system including a plurality of nozzles configured to deliver water to the carts as they move through the modular system; the irrigation system including a plurality of spray nozzles, drip nozzles, or flood nozzles mounted within the body frames to provide water to the carts; a lighting system integrated within the body frames, the lighting system including a plurality of lighting elements configured to emit light towards the carts as they move through the modular system; rollers, tracks, or rack and pinion gears that are configured to move the carts longitudinally across the subframe supports; a harvester frame positioned at one end of the lowest row of the modular system, the harvester frame configured to remove crops from the carts as they reach the end of the serpentine moving path; using, rollers, tracks, or rack and pinion gears, to move the carts longitudinally across the subframe supports within the rows; wherein controlling the movement of the carts includes programming the controller to operate the lowering lift mechanisms and the rollers, tracks, or rack and pinion gears; removing the crops from the carts using a harvester frame positioned at one end of the lowest row of the modular system; and/or adjusting a size of the modular system based on user requirements.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a front perspective view of an illustrative modular grow tower assembly, according to one or more embodiments shown and described herein;

FIG. 2 schematically depicts a rear perspective view of the modular grow tower assembly of FIG. 1, according to one or more embodiments shown and described herein;

FIG. 3 schematically depicts a modular system including a pair of the modular grow tower assemblies of FIG. 1 fixed in a spaced apart manner, according to one or more embodiments shown and described herein;

FIG. 4 schematically depicts a partially exploded view of an illustrative modular grow tower assembly, according to one or more embodiments shown and described herein;

FIG. 5 schematically depicts a body frame of the modular grow tower assembly of FIG. 1, according to one or more embodiments shown and described herein; and

FIG. 6 schematically depicts a pair of body frames of FIG. 5 positioned on a truck platform, according to one or more embodiments shown and described herein.

FIG. 7 depicts a computing device for an exemplary modular grow tower assembly according to one or more embodiments shown and described herein.

### DETAILED DESCRIPTION

Embodiments described herein are directed to modular systems and methods for forming a modular system in which carts of crops may be guided through a growing assembly along a moving path (e.g., serpentine moving path, circular moving path, curved or straight moving path, etc.). Crops may include traditional agricultural materials, for example, seeds and plants, as well as non-traditional materials, for example, eggs, algae, insects, insect larvae, fungi, other kinds of organic material, and/or the like.

The modular system includes a plurality of body frames and a plurality of lowering frames that may be assembled in any number of rows with any number of body frames provided between a pair of lowering frames to create a custom modular grow tower assembly. Whenever possible, the same reference numerals will be used throughout the drawings to refer to the same or like parts.

In various embodiments, the modular grow tower assembly and constituent lift frames and body frames can comprises a variety of materials, such as, but not limited to, aluminum alloys, titanium alloys, carbon fiber reinforced polymer (CFRP), glass fiber reinforced polymer (GFRP), high-strength low-alloy (HSLA) steel, stainless steel, bamboo, composite materials (hybrid), engineered wood products (e.g., cross-laminated timber (CLT)), high-strength thermoplastics (e.g., polycarbonate, polyether ether ketone (PEEK)).

In various embodiments, the lowering lift and/or translating mechanisms of the present disclosure may be powered via pneumatic arms and/or motors, such as a plurality of translating mechanisms positioned along a length of a track, where each translating mechanism has a plurality of motorized apparatuses (e.g., motors) configured to push or pull the carts in a longitudinal direction. Correspondingly, the motorized apparatuses may be configured to push and retrieve the carts using extendable and retractable mechanical mechanisms to move the carts a predetermined length. In various embodiments, such motorized apparatus may be comprise one or more of motors, belts, chains, rollers, tracks, conveyers, rack and pinion gears, hydraulic systems, pneumatic systems, linear actuators, screw jacks, winches, cables and pulleys, gear systems, cam mechanisms, scissor lifts, and/or magnetic levitation systems.

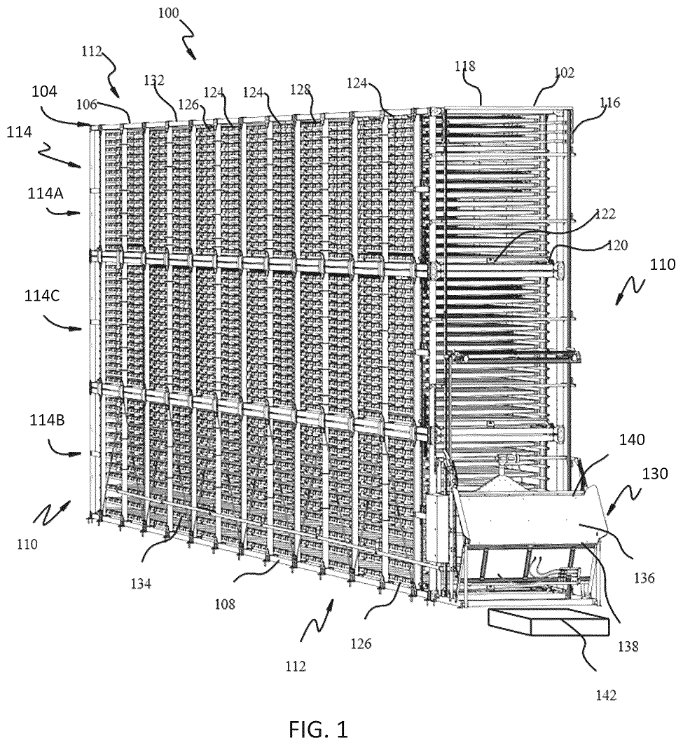

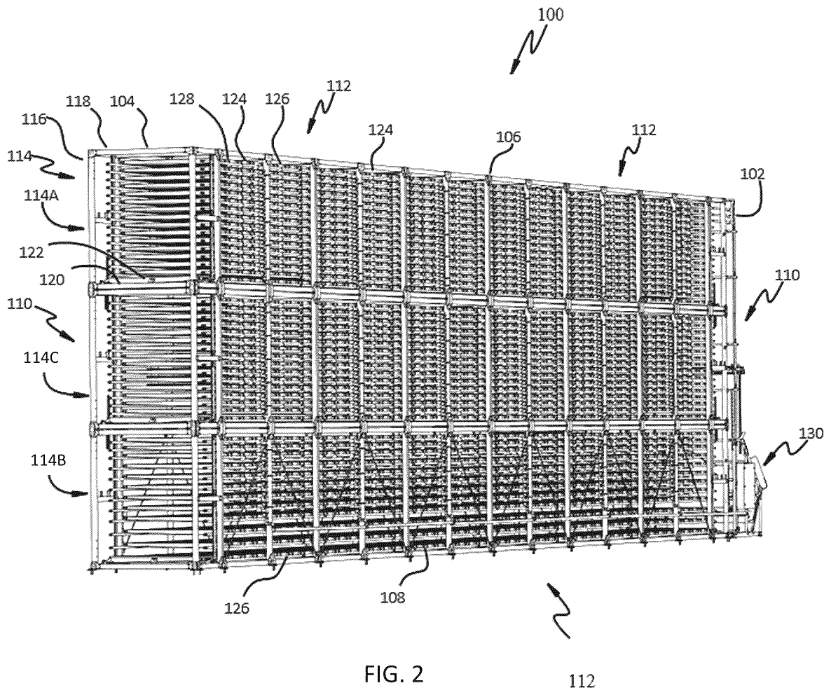

Referring now to FIGS. 1 and 2, a modular grow tower assembly 100 is illustrated according to one or more embodiments described herein. The modular grow tower assembly 100 may generally include a first end 102, a second end 104 opposite the first end 102, a top end 106, and a bottom end 108 opposite the top end 106. As discussed herein, the size of the modular grow tower assembly 100 is customizable based on user requirements and the type of crop to be grown within the modular grow tower assembly 100. The modular grow tower assembly 100 includes a plurality of lowering frames 110 at the first end 102, a plurality of lowering frames 110 at the second end 104, and a plurality of body frames 112 positioned between the lowering frames 110 at the first end 102 and the lowering frames 110 at the second end 104. In embodiments, the modular grow tower assembly 100 also includes one or more lift frames positioned at the first end 102 and/or the second end 104, as discussed in more detail herein.

The plurality of lowering frames 110 and the plurality of body frames 112 are arranged in a plurality of rows 114. Accordingly, each row 114 includes a lowering frame 110 at the first end 102, a lowering frame 110 at the second end 104, and a plurality of body frames 112 provided between each of the lowering frames 110. However, it should be appreciated that only a single body frame 112 may be provided in each row 114. The rows 114 extend in a longitudinal direction and are stacked on top of one another in a vertical direction. As referred to herein, the rows 114 include a top row 114A, a bottom row 114B, and one or more middle rows 114C between the top row 114A and the bottom row 114B. As shown, the illustrative modular grow tower assembly 100 includes three rows 114 with only one middle row 114C provided between the top row 114A and the bottom row 114B. In the example of FIG. 1 and FIG. 2, each row 114 may include six body frames 112 arranged in a linear manner. Thus, this example of the present modular grow tower assembly 100 includes eighteen body frames 112 and six lowering frames 110. However, it should be appreciated that other configurations of the modular grow tower assembly 100 are contemplated as being within the scope of the present application. Thus, other configurations of the modular grow tower assembly 100 may include less than three rows 114, such as one row or two rows, and more than three rows such as four rows, five rows, six rows, etc. In addition, the length of each row 114 may be increased or decreased by including more or less body frames 112 other than the row 114 of six body frames 112 illustrated herein. For example, each row 114 of the modular grow tower assembly 100 may include two body frames 112, five body frames 112, ten body frames 112, or fifteen body frames 112.

The body frames 112 and the lowering frames 110 may be attached to adjacent lowering frames 110 and/or body frames 112. Accordingly, the lowering frames 110 and the body frames 112 may be connected by utilizing any suitable fastening mechanism. Similarly, the lowering frames 110 and the body frames 112 may be disconnected from one another to be rearranged as necessary to adjust the size of the modular grow tower assembly 100, i.e., the number of rows 114 and the number of body frames 112 within each row 114.

Referring still to FIGS. 1 and 2, each lowering frame 110 may be similar in structure. Specifically, each lowering frame 110 includes an enclosure 116 defining a top end 118, a bottom end 120 opposite the top end 118, and a lowering lift mechanism 122 that translates between the top end 118 and the bottom end 120. As discussed in more detail herein, the lowering lift mechanism 122 operates to move carts 124 in a vertical direction to a different row 114 within each body frame 112. The lowering lift mechanism 122 includes any suitable device for moving the carts 124 in the vertical direction such as rollers, tracks, rack and pinion gears, and the like. As described in more detail herein, the carts 124 enter each lowering frame 110 and are lowered in the vertical direction by the lowering lift mechanism 122 such that the carts 124 are moved to a lower position within each row 114. It should be appreciated that the carts 124 are each provided with seed and/or other organic material necessary for growing crops.

In embodiments, each body frame 112 includes a plurality of rows of subframe supports 126. The subframe supports 126 each include a translating mechanism 128 for translating the carts 124 in the longitudinal direction across each of the plurality of body frames 112 in the same row 114. In embodiments, the translating mechanism 128 may be any suitable device for translating the carts 124 such as rollers, tracks, rack and pinion gears, and the like. Accordingly, the translating mechanism 128 movably translates the carts 124 in the longitudinal direction between the lowering frames 110 and across the body frames 112 of each row 114.

In another embodiment, the carts 124 may be rollably mounted within each of the body frames 112 to passively translate between opposite ends of the modular grow tower assembly 100. Specifically, a plurality of carts 124 may be provided within each row of subframe supports 126 and in contact with adjacent carts such that the carts may be moved toward an end of the modular grow tower assembly 100 by being pushed by another cart entering the same row of subframe supports 126.

It should be appreciated that the carts 124 are translated through the modular grow tower assembly 100 along a serpentine moving path. Specifically, the carts 124 move along a first row of subframe supports 126 from one of the lowering frame 110 toward the opposite lowering frame 110. Upon reaching one of the lowering frames 110, the lowering frame 110 translates the cart 124 in a downward vertical direction to the next lower row of subframe supports 126. The cart 124 is then guided onto the subframe support 126 and continues along the subframe support 126 of each body frame 112 until the cart 124 reaches the other lowering frame 110. The process repeats as the cart 124 enters the lowering frame 110 and the lowering frame 110 again moves the cart 124 in the downward vertical direction to the next lower row of subframe supports 126.

Accordingly, it should be appreciated that the distance in which the lowering frame 110 moves each of the carts 124 in the downward vertical direction is equal to a distance between each adjacent row of subframe supports 126 such that the cart 124 is translated along subframe supports 126 of the modular grow tower assembly 100. The process repeats to move the cart 124 along this serpentine moving path throughout each body frame 112 and each lowering frame 110 of the modular grow tower assembly 100 until the cart 124 reaches the lowest row of subframe supports 126 in the bottom row 114B of body frames 112. Thereafter, the cart 124 is guided, such as through the lowering frame 110, to a harvester frame 130 where the matured crops are removed from carts 124, as discussed in more detail herein.

Although not shown, the modular grow tower assembly 100 may include a plurality of growth enhancing components for encouraging growth of the crops based on their position within the modular grow tower assembly 100 and along the serpentine moving path. For example, the modular grow tower assembly 100 may include an irrigation system 132 including a plurality of spray nozzles, drip nozzles, flood nozzles, etc. mounted within the body frames 112 to provide water onto the carts 124 moving there along. The nozzles may be mounted within each of the body frames 112 or only certain body frames 112 within each row 114 of the modular grow tower system. More particularly, the nozzles may be mounted to the subframe supports 126. Thus, the carts 124 receive water when passing through those body frames 112 in which one or more nozzles are mounted.

The modular grow tower assembly 100 may include a lighting system 134 including a plurality of lighting elements for emitting light toward the carts 124. The lighting elements may include, for example, high intensity discharge (HID) lights, fluorescent lights, light-emitting diode (LED) lights, and/or the like. The lighting elements may be mounted within the body frames 112 and directed in a generally downward direction toward an upper surface of the carts 124. More particularly, the lighting elements may be mounted to the subframe supports 126. The lighting elements may be mounted within each of the body frames 112 or only certain body frames 112 within each row 114 of the modular grow tower system. Thus, the carts 124 receive direct light from the lighting elements when passing through those body frames 112 in which one or more lighting elements are mounted. In embodiments, the lighting elements are mounted to body frames 112 in the lowest row of the modular grow tower assembly 100.

As noted above, the modular grow tower assembly 100 further includes the harvester frame 130, as shown in FIG. 1. The harvester frame 130 is provided at either the first end 102 or the second end 104 of the modular grow tower assembly 100 proximate one of the lowering frames 110 at the lowest row of the modular grow tower assembly 100. The harvester is configured to remove the crops that have grown in each of the carts 124 as they reach the end of the serpentine moving path. For example, once the crops reach the end of the serpentine moving path at either the first end 102 or the second end 104 of the lowest row of the modular grow tower assembly 100, the carts 124 are transported to the harvester frame 130. The cart 124 is then positioned on a tray 136 of the harvester frame 130 that is rotatable mounted within the harvester frame 130. Specifically, the tray 136 is positionable between a receiving position and a harvesting position. As shown in FIG. 1, the tray 136 of the harvester frame 130 is in the harvesting position such that a forward end 138 of the tray 136 is tilted lower than an opposite rearward end 140 of the tray 136. As the cart 124 is positioned on the tray 136 and the tray 136 tilts toward the harvesting position, the crops growing in the cart 124 are dislodged and fall into a collection reservoir 142, shown in FIG. 1. Thereafter, the cart 124 is moved out of the harvester frame 130. In embodiments, the cart 124 may be moved back toward the top row 114A of the modular grow tower assembly 100 via the lowering frame 110 or a separate lift frame provided at the first end 102 and/or the second end 104 of the modular grow tower assembly 100. Additionally, the carts 124 may be initially positioned at the top row 114A by the lift frame. In other embodiments, the cart 124 may be entirely removed from the modular grow tower assembly 100 such that the cart 124 may be washed and sanitized prior to further use within the modular grow tower assembly 100.

The modular grow tower assembly further includes a controller and/or other computing device. The controller is programmed to operate the lowering frames 110 and move a plurality of carts 124 provided in the body frame 112 based on the particular crop to be grown.

In various embodiments, the controller or other component of a computing environment for the modular grow tower assembly 100 can monitor and measure sensor data, growth parameters, or other environmental factors, such as, but not limited to, temperature, humidity, light intensity, light duration, light spectrum, water quality/purity, water quantity, watering frequency, water temperature, water polarization, water flow rate, water filtration system efficiency, water mineral content, nutrient concentration, nutrient composition, pH level, airflow, CO₂ concentration, soil type, soil moisture, soil pH, soil composition, tray size and shape, tray material, growth medium, plant density, genetic factors, pollination, growth stage, harvest timing, microbial activity, oxygen levels, feeding frequency (for insects and larvae), substrate type (for fungus), light-dark cycles, movement frequency, sound vibrations, structural support (stakes, netting, cages, trellis, etc.), climatic conditions, altitude/barometric pressure, cleaning/washing/sanitizing/hygiene practices, growth hormones, symbiotic relationships if different crops are mixed, different crop or seed varieties in one tray, amount of human contact, pre-planting treatments or coatings applied to seeds, crop harvest weight, crop color, crop uniformity, crop density, crop level, nutrient content of crop harvests, and/or elemental analysis of crop harvests.

Additional factors that can be measured and/or used to customize tower operations include cart paths, cart maintenance reports, total electricity use, total water use, total seed or crop-starting material amount or weight, total time of carts in motion, total downtime of no motion, maintenance history, usage history, change history, video monitoring of individual systems, video monitoring of facility, user logs, software update history, bug reports, weather, and/or user notes.

The controller includes one or more processors and one or more memory modules. Each of the one or more processors may include any device capable of executing machine readable instructions. Accordingly, each of the one or more processors may include an integrated circuit, a microchip, a computer, or any other computing device. The one or more memory modules may include RAM, ROM, flash memories, hard drives, or any device capable of storing machine readable instructions such that the machine readable instructions may be accessed and executed by the one or more processors. The machine readable instructions may include logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the one or more memory modules. In some embodiments, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Accordingly, information is inputted into the controller identifying certain parameters such as the type of crop being grown and the size of the modular grow tower assembly 100, specifically, how many rows 114 are provided and how many body frames 112 are provided within each row 114. In embodiments, the controller is communicatively coupled to the lowering frames 110 for operating the lowering lift mechanism 122 and communicatively coupled to the body frames 112 for operating the translating mechanism 128, if provided. Specifically, based on the information inputted into the controller, the lowering lift mechanisms 122 and the translation mechanisms are operated to appropriately move the carts 124 along the serpentine moving path and throughout the modular grow tower assembly 100. The controller may also be communicatively coupled to the irrigation system 132 and the lighting system 134 to control operation thereof. For example, the controller may operate the irrigation system 132 and/or the lighting system 134 at predetermined intervals or for predetermined periods of time.

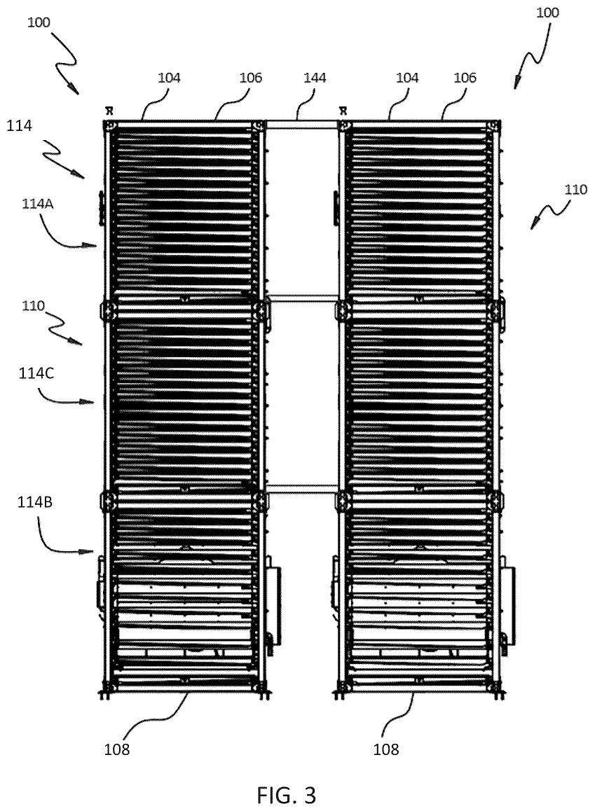

Referring now to FIG. 3, an embodiment of a modular system is illustrated including a pair of modular grow tower assemblies 100 arranged in two spaced apart columns. The modular grow tower assemblies 100 are connected by intermediate frame members 144 to provide enhanced structural integrity. Although the modular system illustrates only a pair of modular grow tower assemblies 100, it should be appreciated that the modular system may include any number of modular grow tower assemblies 100 arranged in spaced apart columns and interconnected by intermediate frame members 144. In embodiments, the intermediate frame members 144 may provide a distance of about twelve feet between adjacent modular grow tower assemblies 100 to comply with specific administrative requirements, such as those instituted by the Occupational Safety and Health Administration (OSHA).

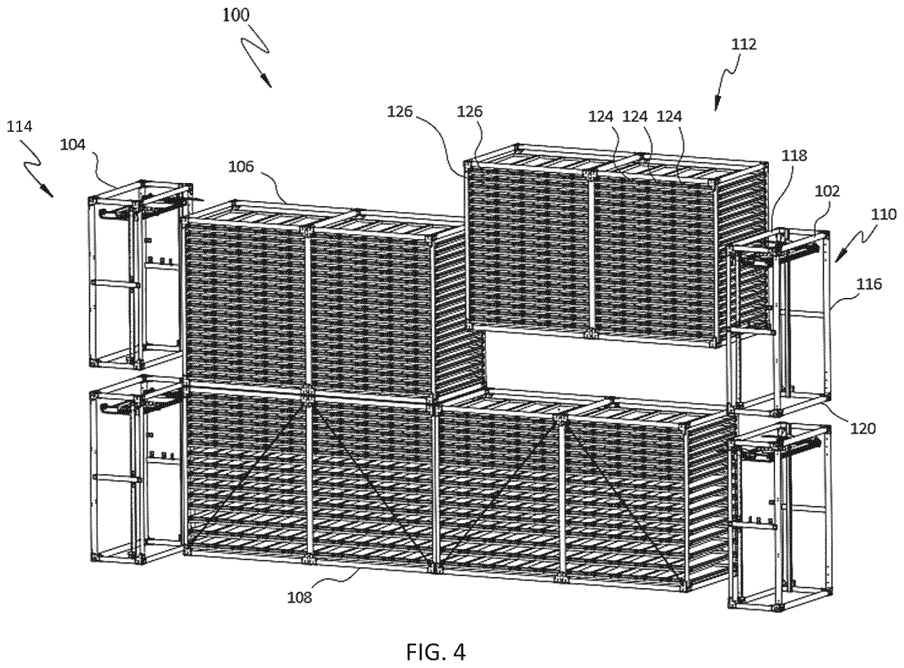

Referring now to FIG. 4, a partially exploded view of an illustrative modular grow tower assembly 100 is illustrated including a pair of rows 114, i.e., a top row and a bottom row, and two body frames 112 within each row 114. As shown, the carts 124 are arranged within each of the body frames 112 to define sub-rows within each body frame 112. As discussed in more detail herein, it should be understood that the number of sub-rows within each body frame 112 is defined by the number of rows of subframe supports 126 within each body frame 112. The body frames 112 within each row 114 include the same number of subframe supports 126. However, the body frames 112 in one row 114 may include a different number of subframe supports 126 as the number of subframe supports 126 in an adjacent row 114, as discussed in more detail herein.

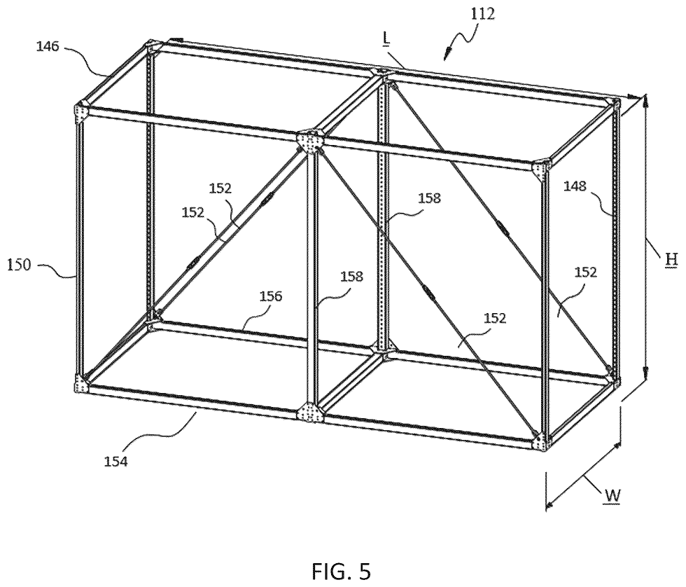

Referring now to FIG. 5, the body frame 112 is illustrated. Each body frame 112 is substantially similar in structure. Specifically, each body frame 112 includes an enclosure 146 defining a first end 148, a second end 150 opposite the first end 148, and the translation mechanism (FIG. 1) that translates the carts 124 between the first end 148 and the second end 150. In embodiments, each body frame 112 includes a pair of diagonal braces 152 extending along a first side 154 of the body frame 112 between the first end 148 and the second end 150, and a pair of diagonal braces 152 extending along an opposite second side 156 of the body frame 112 between the first end 148 and the second end 150.

In embodiments, each body frame 112 includes a plurality of holes 158 for attaching the rows of subframe supports 126. Each subframe support 126 may be removably attached to the body frame 112 using any suitable fastener such as bolts, clips, and the like. The plurality of holes 158 permit the distance between adjacent subframe supports 126 of each body frame 112 to be adjusted. It should be appreciated that the distance between subframe supports 126 in each body frame 112 of the same row 114 is the same such that carts 124 are permitted to seamlessly move between body frames 112 of the same row 114. However, as noted above, the distance between subframe supports 126 in one row 114 of body frames 112 may differ from the distance between subframe supports 126 in a different row 114 of body frames 112. This is due to the fact that as the carts 124 are translated to different rows 114 of body frames 112 by the lowering frames 110 discussed herein, the height of the crops increases and requires more space to grow.

Thus, referring again to FIGS. 1 and 2, the distance between subframe supports 126 may be greater in lower rows 114 of body frames 112 than the distance between subframe supports 126 in the top row 114A of body frames 112. Particularly, the distance between subframe supports 126 in the top row 114A of body frames 112 may be less than the distance between subframe supports 126 in the middle row 114C of body frames 112, and the distance between subframe supports 126 in the middle row 114C of body frames 112 may be less than the distance between subframe supports 126 in the bottom row 114B of body frames 112. As a non-limiting example, the distance between adjacent subframe supports 126 in the bottom row 114B may be about 8 inches, about 9 inches, or about 10 inches, the distance between adjacent subframe supports 126 in the middle row 114C may be about 5 inches, about 6 inches, or about 7 inches, and the distance between adjacent subframe supports 126 in the middle row 114C may be about 2 inches, about 3 inches or about 4 inches. As such, the distance between adjacent subframe supports 126 is greater in lower rows 114 of the body frames 112 as compared to and immediately adjacent upper row 114 of body frames 112.

Referring again to FIG. 5, in embodiments, each body frame 112 has a width W ranging from about 6 feet to about 10 feet, a height H ranging from about 6 feet to about 10 feet, and a length L ranging from about 18 feet to about 26 feet. In embodiments, each body frame 112 has a width W ranging from about 7 feet to about 9 feet, a height H ranging from about 7 feet to about 9 feet, and a length L ranging from about 20 feet to about 24 feet. In embodiments, each body frame 112 has a width W of about 8 feet, a height H of about 8 feet, and a length L of about 22 feet. The lowering frames 110 (FIG. 4) have a height corresponding to the height H of the body frame 112. However, it should be appreciated that the dimensions of the body frame 112 and the lowering frame 110 may be adjusted according to the user's specific needs. In embodiments, the modular grow tower assembly 100 may include a universal connector used to facilitate mechanical, fluid, and/or electrical connection between two or more of the lowering frames 110 and/or the body frames 112.

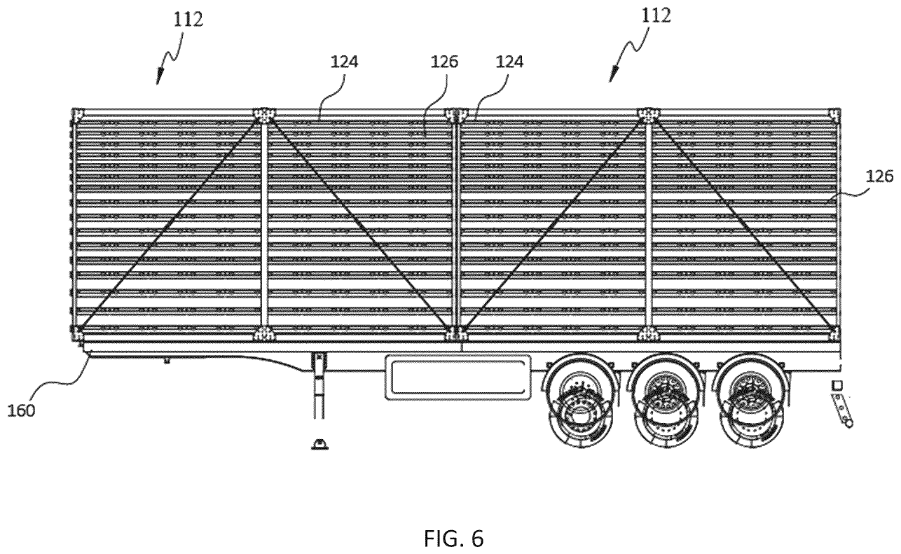

Referring now to FIG. 6, a pair of body frames 112 are illustrated on a vehicle bed 160 to be transported. The lowering frames 110 and the body frames 112 are shaped and sized for transporting on a standard rail car, standard semi-truck, and/or other standard transport vehicle, such that the lowering frames 110 and the body frames 112 may be constructed at an initial manufacturing site as standard components and subsequently assembled at a destination site to form the custom modular grow tower assembly. As noted above, each body frame 112 may have a length in excess of about 18 feet, for example, about 20 feet, about 22 feet, about 24 feet, or about 26 feet. In embodiments, the length of the body frame 112 is about 22 feet and two individual body frames 112 may be arranged on the vehicle bed 160 to be transported. Thus, the vehicle bed 160 has a length of at least about 44 feet.

It should be appreciated that the components discussed herein may be customized in any number of different configurations to provide a customer a custom modular grow tower assembly based on the customer's particular needs. It is intended that a customer may place an order for a custom modular grow tower assembly by specifying how many rows 114 of body frames 112 are required, the length of each row 114 of body frames 112, and the distance between subframe supports 126 within each row 114 of body frames 112. Thereafter, the customer receives a pair of lowering frames 110 for each row 114 and the required number of body frames 112 for each row 114. In addition, the subframe supports 126 may be preinstalled within each body frame 112 based on the particular location of the body frame 112 within the custom modular grow tower assembly and the customer's requirements. The customer may also be provided with a harvester frame 130, a controller, and any other growth enhancing components such as an irrigation system 132 and a lighting system 134. The custom modular grow tower assembly may then delivered to the customer and assembled on site according to the customer's specifications.

The custom modular grow tower assembly may also be determined based on the customer's desired output and size. Based on the information provided by the customer, the size of the custom modular grow tower assembly may be determined. Furthermore, the number of body frames 112 and lowering frames 110 is then determined based on the determined size of the custom modular grow tower assembly.

From the above, it is to be appreciated that defined herein is a modular system for guiding carts of seed along a moving path defined by a number of body frames provided between a pair of lowering frames in which the body frames and the lowering frames are arranged in a plurality of rows according to customer specifications. In various embodiments, the moving path may take various shapes. For example, the moving path may comprise a serpentine path, such as one that starts from the top, moving trays horizontally in one direction, then down one sequential row as they reach the end of the horizontal path. The trays then move in the opposite horizontal direction along the new row, then down another row to continue the same pattern, and so forth. Alternatively, in various embodiments, the moving path may comprise a C-Shape path, such that carts may move horizontally in one direction on the top half of the total rows, then down to the bottom half of the total rows where the lighting system may be located. The carts may then move horizontally in the opposite direction, being harvested at the bottom. Correspondingly, in some embodiments, the moving path may comprise alternating rows/skipping rows path such that carts may move from row A to row C and then, subsequently, carts may move from row B to row D, instead of A to B to C to D in sequence. Further, in various embodiments, the moving path may having batching collections of rows such that groups of rows may be set and left without movement for many days and then all moved to a new set of rows with different heights or systems in one rapid succession. For example, rows A, B, C, and D may be batched to be moved on the same day to rows I, J, K, and L, while rows E, F, G, and H remain stationary until the following day. Additionally, in various embodiments, the moving path may comprise a haphazard path such that carts from the top rows can be moved down to any of the lower rows where different systems such as nutrients, lighting, watering, and measuring are located, and then moved back up again to the same row of origin or another row, offering full versatility.

Thus, the motion of carts does not need to follow a serpentine path nor is it limited to one set sequence. One possible method of moving carts in a modular grow tower assembly may be alternating which row carts are moved to, in a non-sequential or non-serpentine path. This alternating method only moves carts when necessary, to designated new rows of the modular grow tower assembly, based on specific growing requirements such as crop height, row spacing, lighting elements, nutrient application systems, visual inspections, harvesting, and/or washing. This method optimizes the movement of carts by reducing the overall motion required and consequently minimizing wear on the carts and the need for an extensive motion system.

In various embodiments, the alternating rows method is controlled by a computer program executed by the controller that dictates the sequence of cart movements based on specific growing requirements. For instance, the system can start by moving a cart from the top row to row A, and in the next cycle, move another cart from the top row to row B. This sequence can be customized to suit various growing conditions, ensuring that carts are moved efficiently and only when necessary.

Such a method allows for grouping certain rows together and alternating the movement of these groups. For example, the system can alternate between moving carts in rows A, C, and E in one cycle and rows B, D, and F in the next cycle. Another possibility is moving carts from row A to C in one cycle, then only move carts from rows B to D in the next. Another possibility is moving carts from rows A, B, and C to the next level of rows D, E, and F or even to the bottom rows, for the sake of example could be labeled X, Y, and Z. This reduces the overall motion required during an entire grow cycle of a crop from start to finish, thereby lowering the wear on the carts and minimizing the demand on lift mechanisms.

Another option, in various embodiments, is allowing different rows of carts to be consolidated together into one entirely new row, and another possibility is individual carts can alternately be sent to a different row during a movement cycle. This is particularly useful when rows are spaced at different heights, and therefore accommodate continually growing crops. Another possible benefit is minimizing the cost of lighting systems by only requiring lighting on one or two rows. There are many other reasons to justify providing flexibility of cart paths and allowing consolidating rows. Accordingly, alternating and shuffling carts and rows can be performed in a large variety of ways in accordance with the present disclosure.

In various embodiments, the non-sequential movement of the carts is controlled by a computer program executed by the controller, which dictates the cart movement sequence based on the specific growing requirements. This sequence can be customized in other variations to suit various growing conditions, grow times of different crops, reducing the frequency of cart movements and enhancing system efficiency. Correspondingly, a cart tracking system of sensors can allow the controller to keep track of the location of each cart and monitor the growing properties of the crops inside each cart. In various embodiments, the controller can also be configured to allow users to test and predict different patterns of cart movements to discover optimal cart pathways and patterns.

From the above, it is to be appreciated that defined herein is a modular system for guiding carts of crops along a serpentine moving path defined by a number of body frames provided between a pair of lowering frames in which the body frames and the lowering frames are arranged in a plurality of rows according to customer specifications.

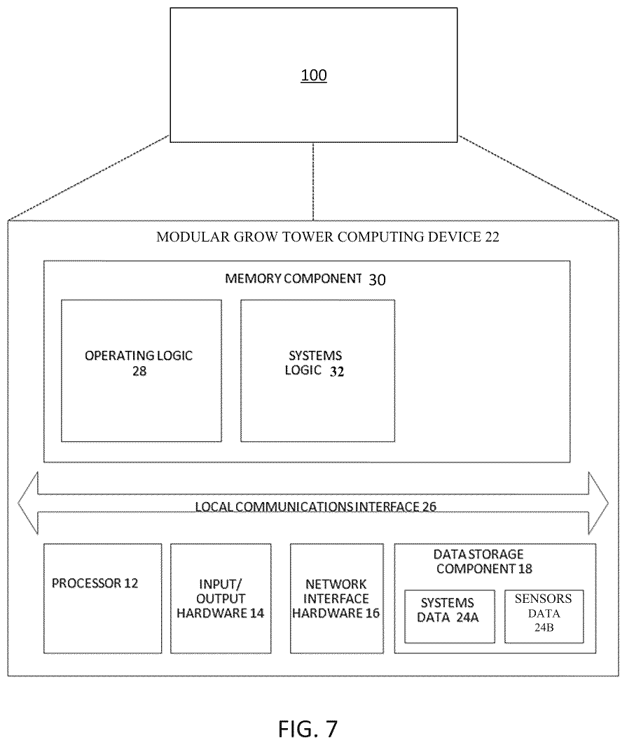

FIG. 7 illustrates a computing “controller” device 22, according to embodiments described herein. As discussed above, the computing device 22 includes a memory component 30, a processor 12, input/output hardware 14, network interface hardware 16, and a data storage component 18 (which stores systems data 24A, sensor data 24B, and/or other data). Each of the components of the computing device 22 may be communicatively coupled to a local communications interface 26. The local communications interface 26 is generally not limited by the present disclosure and may be implemented as a bus or other communications interface to facilitate communication among the components of the computing device (e.g., processor) coupled thereto.

The memory component 30 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), Blu-Ray discs, and/or other types of non-transitory computer-readable mediums. Depending on the particular embodiment, these non-transitory computer-readable mediums may reside within or outside the computing device 22. The memory component 30a may store, for example, operating logic 28 and the systems logic 32. The operating logic 28 and the systems logic 32 may each include a plurality of different pieces of logic, each of which may be embodied as a computer program, firmware, and/or hardware, as an example.

The operating logic 28 may include an operating system and/or other software for managing components of the computing device 22. As discussed above, the systems logic 32 may reside in the memory component 30a and may be configured to perform the functionality, as described above. In some embodiments, the systems logic 32 may reside on different computing devices. As an example, one or more of the functionalities and/or components described herein may be provided by a user computing device and/or remote computing device. While the computing device 22 is illustrated with the systems logic 32 as separate logical components, this is only an example. In some embodiments, a single piece of logic (and/or several linked modules) may cause the computing device 22 to provide the described functionality.

The processor 12 may include any processing component operable to receive and execute instructions (such as from the data storage component 18 and/or the memory component 30a). Illustrative examples of the processor 12 include, but are not limited to, a computer processing unit (CPU), a many integrated core (MIC) processing device, an accelerated processing unit (APU), a digital signal processor (DSP). In some embodiments, the processor 12 may be a plurality of components that function together to provide processing capabilities, such as integrated circuits (including field programmable gate arrays (FPGA)) and the like.

The input/output hardware 14 may include and/or be configured to interface with microphones, speakers, a display, and/or other hardware. That is, the input/output hardware 14 may interface with hardware that provides a user interface or the like. The user interface may include a graphical user interface (GUI) comprising various interactive elements such as buttons, menus, display graphs, icons, sliders, and text fields. The GUI is designed to facilitate user interaction with the system, providing visual representations of data and controls to improve the overall usability and efficiency of the system. The graphical elements may be arranged in a layout that is intuitive and accessible, allowing users to navigate the interface and perform desired actions with ease.

The network interface hardware 16 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the computing device 22 and other computing devices, such as a user computing device, a remote computing device, and/or other devices.

The data storage component 18 may generally be any medium that stores digital data, such as, for example, a hard disk drive, a solid state drive (SSD), a compact disc (CD), a digital versatile disc (DVD), a Blu-Ray disc, and/or the like. It should be understood that the data storage component 18 may reside local to and/or remote from the computing device 22 and may be configured to store one or more pieces of data and selectively provide access to the one or more pieces of data.

It should be understood that while the components in FIG. 11 are illustrated as residing within the computing device 22, this is merely an example. In some embodiments, one or more of the components may reside external to the computing device 22. It should also be understood that, while the computing device 22 is illustrated as a single device, this is also merely an example. That is, the computing device 22 may represent a plurality of devices that are communicatively coupled to one another and provide the functionality described herein.

Additionally, while the computing device 22 is illustrated with the various logic components (e.g., the operating logic 28 and the systems logic 32) and data components (e.g., the systems data 24A, sensors data 24B) as separate components, this is also an example. In some embodiments, a single piece of logic (and/or a plurality of linked modules) and/or a single data component (and/or a plurality of linked modules) may also cause the computing device 22 to provide the functionality described herein.

Similarly, while the computing device 22 is depicted in a “PC” environment, it should be understood that at least some embodiments may not be limited in this way. Specifically, some embodiments may be configured such that the computing device 22 is configured as and/or includes a programmable logic controller (PLC) and/or other computing infrastructure.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A modular system for growing crops, comprising:
a plurality of body frames;
a plurality of lift frames positioned at each end of the modular system;
wherein the body frames and lift frames are arranged in a plurality of vertically stacked rows, each row comprising at least one body frame and two lift frames, the body frames being positioned between the lift frames in each row;
a plurality of subframe supports within each body frame, each subframe support configured to hold at least one cart containing seeds or crops;
a lowering lift mechanism within each lift frame, configured to move the carts vertically between the rows of body frames; and
a controller communicatively coupled to the lowering lift mechanisms and translating mechanisms, configured to operate the movement of the carts through the modular system based on predetermined parameters.

2. The system of claim 1, further comprising:
an irrigation system integrated within the body frames, the irrigation system including a plurality of nozzles configured to deliver water to the carts as they move through the modular system.

3. The system of claim 2, further comprising a lighting system integrated within the body frames, the lighting system including a plurality of lighting elements configured to emit light towards the carts as they move through the modular system.

4. The system of claim 1, wherein the lowering lift mechanism comprises rollers, tracks, or rack and pinion gears, configured to move the carts vertically between the rows.

5. The system of claim 1, further comprising rollers, tracks, or rack and pinion gears that are configured to move the carts longitudinally across the subframe supports.

6. The system of claim 1, further comprising a harvester frame positioned at one end of the lowest row of the modular system, the harvester frame configured to remove crops from the carts as they reach the end of the serpentine moving path.

7. The system of claim 1, wherein the lighting system includes high intensity discharge (HID) lights, fluorescent lights, or light-emitting diode (LED) lights mounted within the body frames to emit light towards the carts.

8. A method for growing crops in a modular system, comprising:
providing a plurality of body frames and lift frames;
arranging the body frames and lift frames in a plurality of vertically stacked rows;
placing carts containing seeds or crops within the body frames;
using a lowering lift mechanism to move the carts vertically between the rows of body frames;
controlling the movement of the carts through the modular system using a controller;
providing water to the carts using an integrated irrigation system; and
providing light to the carts using an integrated lighting system.

9. The method of claim 8, wherein the lowering lift mechanism comprises rollers, tracks, or rack and pinion gears, configured to move the carts vertically between the rows.

10. The method of claim 8, further comprising using, rollers, tracks, or rack and pinion gears, to move the carts longitudinally across the subframe supports within the rows.

11. The method of claim 8, wherein controlling the movement of the carts includes programming the controller to operate the lowering lift mechanisms and the rollers, tracks, or rack and pinion gears.

12. The method of claim 8, further comprising removing the crops from the carts using a harvester frame positioned at one end of the lowest row of the modular system.

13. The method of claim 8, wherein the irrigation system includes a plurality of spray nozzles, drip nozzles, or flood nozzles mounted within the body frames to provide water to the carts.

14. The method of claim 8, wherein the lighting system includes high intensity discharge (HID) lights, fluorescent lights, or light-emitting diode (LED) lights mounted within the body frames to emit light towards the carts.

15. The method of claim 8, further comprising adjusting a size of the modular system based on user requirements.
